(19) United States
(12) Patent Application Publication
(10) Pub. No.: US 2024/0282291 A1
(43) Pub. Date: Aug. 22, 2024

(54) Speech Reconstruction System for Multimedia Files

(71) Applicant: Meta Platforms Technologies, LLC, Menlo Park, CA (US)

(72) Inventor: Wei-Ning Hsu, Long Island City, NY (US)

(21) Appl. No.: 18/582,632

(22) Filed: Feb. 20, 2024

Related U.S. Application Data
(60) Provisional application No. 63/447,113, filed on Feb. 21, 2023.

(51) Int. Cl. G10L 13/027; G10L 13/047; G10L 15/25; G10L 21/0208

(52) U.S. Cl. CPC G10L 13/027; G10L 13/047; G10L 15/25; G10L 21/0208

(57) ABSTRACT

A speech recognition system may determine speech in the presence of multiple, different forms of corrupted audio. The system may obtain audio-visual data including visual data associated with a person and audio data associated with the person. The system may also determine, based on the visual data, pronunciation data associated with speech by the person. The system may also convert the speech to encoded data. The system may also synthesize, based on the encoded data, the speech to obtain synthesized speech.

### CROSS-REFERENCE TO RELATED APPLICATIONS

This application claims the benefit of U.S. Provisional Application No. 63/447,113, entitled “REVISE: SELF-SUPERVISED SPEECH RESYNTHESIS WITH VISUAL INPUT FOR UNIVERSAL AND GENERALIZED SPEECH ENHANCEMENT,” filed Feb. 21, 2023, the entirety of which is incorporated herein by reference.

### TECHNICAL FIELD

This application is directed to speech recognition, and more particularly, to reconstructing speech from a person recorded in a media file that also includes corrupted audio.

### BACKGROUND

Various systems may be utilized to recognize speech, including spoken language, from a multimedia file with corrupted audio. Typically, one system is constructed to manage a particular form of corrupted audio (e.g., speech inpainting), while another system is constructed to manage another form of corrupted audio (e.g., speech with lower intelligibility due to environmental noise in the background). In this regard, systems may include a model trained for the particular form of corrupted audio, while the training may render the model unsuitable for handling other forms corrupted audio.

### BRIEF SUMMARY

Some examples of the present disclosure are directed to devices (e.g., a head-mounted display, a communication device) that includes one or more machine learning models designed to generate synthesized speech and/or text and replace corrupted audio in multimedia content and/or a multimedia file with the synthesized speech and/or text. The one or more machine learning models may rely on visual cues from a person captured in the multimedia content and/or multimedia file as well as predicted pronunciation tokens corresponding to the visual cues.

In some aspects of the present disclosure a speech recognition system may be provided that may determine speech in the presence of multiple, different forms of corrupted audio. The speech recognition system may include a pseudo audio-visual model (P-AVSR) that may receive data that may include both video (of a person/speaker) as well as audio. The audio may include corrupted audio (e.g., background noise, speech from other people) and may determine pronunciation data from visual content (e.g., a person's mouth movements). Thus, the audio-visual model may rely on visual cues in the form of phonetic units to determine the textual data from speech. Additionally, the speech recognition system may include a self-supervised learning (SSL) tokenizer that may receive the determined textual data and may convert the textual data into clean speech. The SSL tokenizer may determine sounds made by a letter or sequence of letters, thus determining the sounds made based on the textual data. The sounds recognized/determined by the SSL tokenizer may include human speech. The determined speech (e.g., the human speech) may be synthesized to match the received textual data, and may be presented as computer-generated synthesized speech and/or text.

In one example aspect of the present disclosure, a method that enables a device(s) to reconstruct speech based on a multimedia file and/or multimedia content is provided. The method may include obtaining audio-visual data comprising i) visual data associated with a person and ii) audio data associated with the person. The method may further include determining, based on the visual data, textual data associated with speech by the person. The method may further include converting the speech to encoded data. The method may further include synthesizing, based on the encoded data, the speech to obtain synthesized speech.

In another example aspect of the present disclosure, a device to reconstruct speech based on a multimedia file and/or multimedia content is provided. The device may include one or more processors and a memory including computer program code instructions. The memory and computer program code instructions are configured to, with at least one of the processors, cause the device to obtain audio-visual data comprising i) visual data associated with a person and ii) audio data associated with the person. The memory and computer program code are also configured to, with the processor, cause the device to determine, utilizing a first model, textual data associated with speech by the person, based on the visual data. The memory and computer program code are also configured to, with the processor, cause the device to convert, utilizing a second model, the speech to encoded data. The memory and computer program code are also configured to, with the processor, cause the device to synthesize, utilizing the second model, the speech to obtain synthesized speech based on the encoded data. Additionally, optionally or alternatively in some examples of the present disclosure, the memory and computer program code may also be configured to, with the processor, cause the device to present the audio-visual data and the synthesized speech. In some aspects of the present disclosure, the device may present, by a display and a speaker, the audio-visual data and the synthesized speech. For example, the display may play or render the visual content of the audio-visual data and the speaker may play or output the audio content of the audio-visual data and the synthesized speech.

In yet another example aspect of the present disclosure, a computer program product that enables a device(s) to reconstruct speech based on a multimedia file and/or multimedia content is provided. The computer program product includes at least one computer-readable storage medium having computer-executable program code instructions stored therein. The computer-executable program code instructions may include program code instructions configured to obtain audio-visual data comprising i) visual data associated with a person and ii) audio data associated with the person. The computer program product may further include program code instructions configured to determine, utilizing a first model, textual data associated with speech by the person based on the visual data. The computer program product may further include program code instructions configured to convert, utilizing a second model, the speech to encoded data. The computer program product may further include program code instructions configured to synthesize, utilizing the second model, the speech based on the encoded data to obtain synthesized speech.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Certain features of the subject technology are set forth in the appended claims. However, for purpose of explanation, several examples of the subject technology are set forth in the following figures.

FIG. 1 illustrates a display presenting a media file or media content, in accordance with aspects of the present disclosure.

FIG. 2 illustrates a block diagram of a system for reconstructing speech from a media file or media content, in accordance with aspects of the present disclosure.

FIG. 3 illustrates an additional block diagram of the system shown in FIG. 2, showing further features and functionality of the system, in accordance with aspects of the present disclosure.

FIG. 4A, FIG. 4B, and FIG. 4C illustrate exemplary movements of a person, in accordance with aspects of the present disclosure.

FIG. 5 illustrates an example of a flowchart illustrating operations for devices that may reconstruct speech from a multimedia file or multimedia content, in accordance with aspects of the present disclosure.

FIG. 6 illustrates an example of a flowchart illustrating alternate operations for devices that may reconstruct speech from a multimedia file or multimedia content, in accordance with aspects of the present disclosure.

FIG. 7 illustrates a diagram of an example of an artificial reality system in accordance with aspects of the present disclosure.

FIG. 8 illustrates an example of a machine learning framework including machine learning model and training database, in accordance with aspects of the present disclosure.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein.

The present disclosure is directed to a speech enhancement system designed to determine and synthesize speech from a multimedia file that includes speech from a person present in the multimedia file. In particular, the system may determine and synthesize the person's speech even in the presence of corrupted audio in the multimedia file. Further, the speech enhancement system may utilize multiple models pre-trained on different datasets, thus allowing the speech enhancement system to manage multiple forms of corrupted audio, such as loss of partial audio, loss of entire audio, overlapping with speech from other speakers, overlapping with environmental noise. The speech enhancement system may provide a more efficient speech synthesis approach as compared to using multiple, discrete systems.

In one or more implementations, the system includes a pseudo audio-visual speech recognition (P-AVSR) model that receives data in the form of a multimedia file that includes both video as well as audio of a person speaking, the latter of which may include corrupted audio (e.g., background noise, speech from other people, poor microphone performance). The P-AVSR model may include a speech recognition model designed to determine what the person speaking is saying based on both audio and visual cues, and output the determined speech as pronunciation data. For example, the P-AVSR model may be pre-trained to rely on mouth movement of the person. Generally, people tend to have similar mouth movements for particular sounds (e.g., “ahh” sound, “eee” sound, “ohh” sound). Moreover, the P-AVSR model may rely on the visual cues independently of the recorded audio, and output the pronunciation data based on the visual cues (e.g., mouth movements of the person), including in some instance only through the use of visual cues. Beneficially, the P-AVSR model may not be negatively impacted by corrupted audio in a multimedia file. Moreover, using visual cues may allow the system to manage multiple forms of corrupted audio, thus allowing the system to function as a universal speech enhancement system that manages different forms of corrupted audio in a multimedia file by determining speech in spite of different forms of corrupted audio.

Additionally, the speech enhancement system may include a self-supervised language (SSL) tokenizer model designed to encode clean speech audio (e.g., speech without corruption) into pronunciation tokens. Prior to utilization, the SSL tokenizer model may be pre-trained by one or more datasets with speech (e.g., clean speech). Through training, the SSL tokenizer model may learn particular sounds in words, and assign encoded data (e.g., a token in the form of an encoded number or alphanumeric phrase) to each particular sound. For example, an “ahh” sound may be encoded, or tokenized, as 10, an “eee” sound may be encoded as 20, and an “ohh” sound may be encoded as 30.

The SSL tokenizer, when trained, may create training data used to train the P-AVSR model. In this regard, given a multimedia file that includes both video and audio, the P-AVSR model, once trained, may be designed to predict the pronunciation tokens. The P-AVSR model may generate a token to each perceived sound that may be made based on the video and the audio. Moreover, the audio may include corrupted audio.

The speech enhancement system may further include a token-to-speech (TTS) model. Similar to the P-AVSR model, the TTS model may also be trained on data generated by the SSL tokenizer. Using the sequence of tokens generated by the P-AVSR model, the TTS model may output synthesized speech in the form of computer-generated spoken language or computer-generated text. A system incorporating synthesized speech in this manner offers several advantages. For example, when speech is determined from corrupted audio and the corrupted audio is removed, the computer-generated synthesized speech and/or text may be played (e.g., rendered, outputted, etc.) over the corrupted audio in the multimedia file and synchronized with the mouth movement of the person in the multimedia file. In this regard, any missing speech from the person in the multimedia file due to corruption is accounted for by the computer-generated synthesized speech and/or text.

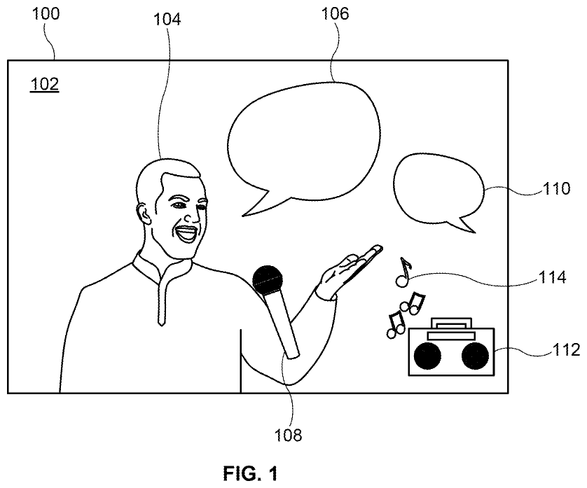

These and other embodiments are discussed below with reference to FIGS. 1-7. However, those skilled in the art will readily appreciate that the detailed description given herein with respect to these Figures is for explanatory purposes only and should not be construed as limiting.

FIG. 1 illustrates a display 100 presenting a media file 102, in accordance with aspects of the present disclosure. The media file 102, representative of other media files shown and/or described herein, may include a multimedia file with both audio and video components. In this regard, the media file 102 may take the form of a recorded audio-visual file that is stored on a storage device, such as memory on a server or another computing system, and capable of playback through, for example, the display 100. As shown, a person 104 (e.g., real human, animated character) is speaking, as indicated by the bubble 106. The media file 102 may utilize a microphone 108 to record the person 104. In addition to the person 104 speaking, the media file 102 may include other forms of sound detected by the microphone 108. For example, the media file 102 may include an “off-camera” person or persons speaking in the background, as indicated by a bubble 110. Additionally, a media player 112 is playing (e.g., rendering or outputting) music 114.

In some instances, the other forms of sounds detected by the microphone 108 may corrupt the speech of the person 104. Moreover, the microphone 108 may undergo a fault and no audio is available of the person 104 during the fault. Other issues, such as Internet connection issues, may arise while recording the media file 102, thus reducing the overall quality of the audio in the media file 102. Any one or more of the aforementioned issues may be present in the media file 102, and the speech from the person 104 may not be fully comprehendible. In some examples of the present disclosure, the media file 102 may be referred to herein as media content 102.

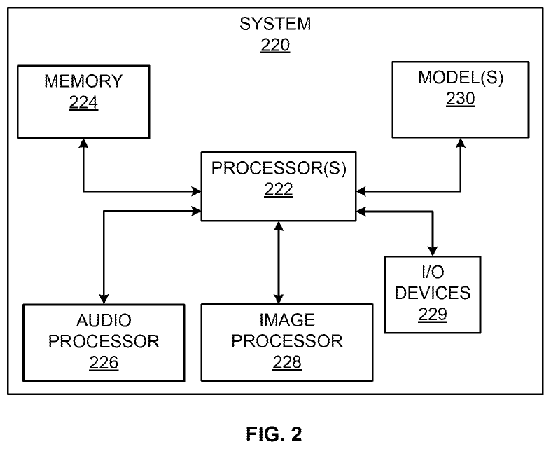

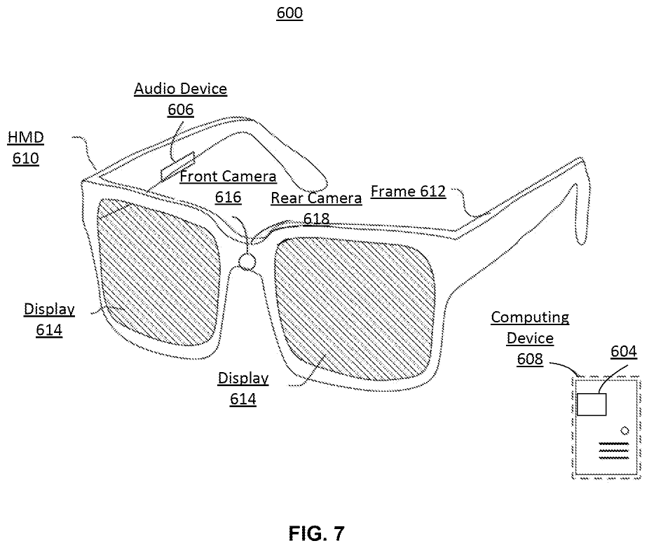

FIG. 2 illustrates a block diagram of a system 220 for reconstructing speech from a media file, in accordance with aspects of the present disclosure. In some examples of the present disclosure, the system 220 may be referred to herein as a communication device. In some examples of the present disclosure, the system 220 may be a single integrated standalone device. In other examples of the present disclosure, one or more components of the system 220 may be remote from the system 220. In some examples, the system 220 may, but need not, be a head-mounted display (HMD) (e.g., HMD 610 of FIG. 7), smart glasses, an augmented/virtual reality device and/or the like. The system 220 may be used to recognize relevant speech from a media file and/or media content (e.g., speech from/associated with the person 104 in which the speech is in the media file 102 shown in FIG. 1), convert the relevant speech (e.g., speech from/associated with a person) to pronunciation tokens, and convert the pronunciation tokens to computer-generated synthesized speech. In this regard, the system 220 may take the form of a speech recognition system.

As shown, the system 220 may include one or more processors 222. As non-limiting examples, the one or more processors 222 may include circuitry such as a central processing unit (CPU), a graphics processing unit (GPU), one or more microcontrollers, one or more micro-electromechanical system (MEMS) controllers, an application-specific integrated circuit (ASIC), or a combination thereof.

The system 220 may further include a memory circuit 224 in communication with the one or more processors 222. The memory circuit 224 may include read-only memory (ROM), random access memory (RAM), or a combination thereof. The one or more processor 222 may execute instructions stored on the memory circuit 224, such as recognize speech recognition instructions and speech synthesis instructions.

The system 220 may further include an audio processor 226 in communication with the one or more processors 222. The audio processor 226 is designed to analyze audio data from a media file and determine the various types of audio, including whether the audio is attributed to a person speaking on the media file, to other persons are speaking, and to background noise. The audio processor 226 may be implemented as software stored on the memory circuit 224 or as hardware via the one or more processors 222. Alternatively, the audio processor 226 may be part of a microphone (not shown in FIG. 2).

The system 220 may further include an image processor 228 in communication with the one or more processors 222. The image processor 228 is designed to analyze image data for a visual cue (e.g., mouth movement), or visual cues, of a person (e.g., person 104 in FIG. 1). For example, the image processor 228 may process images while a person is speaking to determine phonetic units the person makes with his or her mouth while speaking. As a result, the image processor 228 may determine the type of sound the person makes while speaking based on visual cues. The image processor 228 may be implemented as software stored on the memory circuit 224 or as hardware via the one or more processors 222. Further, the image processor 228 may recognize speech independently of the audio processor 226.

The system 220 may further include one or more input-output devices 229 (I/O DEVICES) in communication with the one or more processors 222. As non-limiting examples, the input-output devices 229 may include a display (representative of one or more displays), a microphone (representative of one or more microphones), and a speaker (representative of one or more audio speakers). As a non-limiting example, the system 220 may take the form of a head-mounted device (HMD).

The system 220 may further include one or more models 230 in communication with the one or more processors 222. As non-limiting examples, the one or models 230 may include a speech recognition model, a self-supervised learning model, and a token-to-speech model. The one or more models 230 may be implemented as software stored on the memory circuit 224 or as hardware via the one or more processors 222.

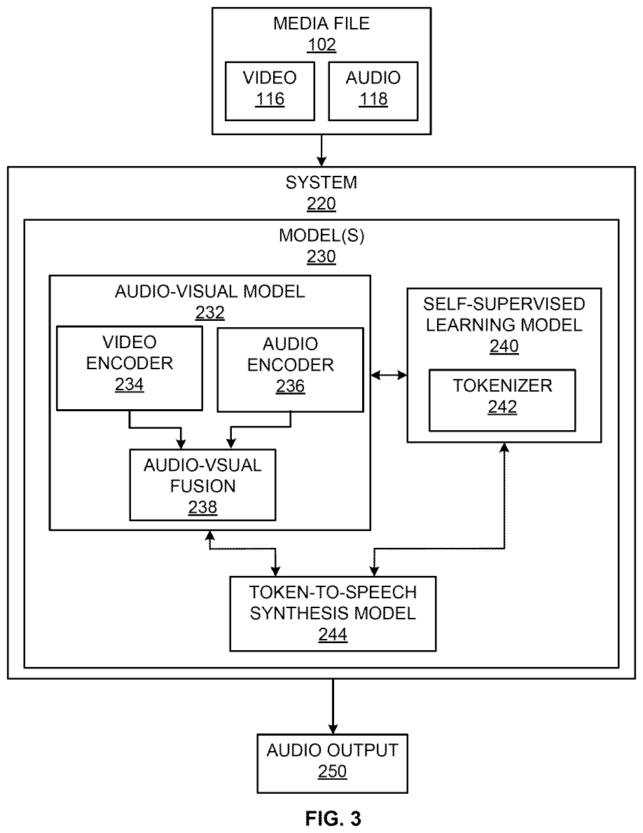

FIG. 3 illustrates an additional block diagram of the system 220 shown in FIG. 2, showing further features and functionality of the system 220, in accordance with aspects of the present disclosure. As shown, the system 220 may receive the media file 102 (e.g., media content) that includes a video portion 116 and an audio portion 118. The video portion 116 and the audio portion 118 may include a digitally stored representation of images and sound, respectively, of the media file 102. Also, in some instances, the audio portion 118 include corrupted audio in which the speech of a person in the media file 102 is difficult to comprehend.

The one or more models 230 may include an audio-visual model 232. In one or more implementations, the audio-visual model 232 takes the form of a P-AVSR model. In this regard, the audio-visual model 232 may take the form of a speech recognition model designed to recognize speech of a person (e.g., person 104 shown in FIG. 1) and convert the recognized speech into pronunciation tokens, with the pronunciation tokens corresponding to the speech by the person as determined by the audio-visual model 232. In particular, the audio-visual model 232 may analyze (e.g., sample) the video portion 116 of the media file 102 to determine visual cues (e.g., mouth movements) of a person in the media file 102. In this regard, the audio-visual model 232 may determine phonetic units based on the determined mouth movements of the person in the media file 102. The audio-visual model 232 may be trained with data (e.g., video data, audio data, pronunciation data) with various images of visual cues, such as mouth movements, and respective sounds made with a particular visual cue (e.g., particular mouth movement). Accordingly, the audio-visual model 232 may learn to recognize pronunciation associated with a sequence of particular mouth movements. Moreover, the audio-visual model 232 may effectively ignore the audio portion 118 of the media file 102, and use only the visual cues. Beneficially, any corrupted portion (or corrupted portions), in the form of background noise or other persons speaking, of the audio portion 118 is removed and does not impact the pronunciation tokens determined by the audio-visual model 232.

The audio-visual model 232 may include a video encoder 234, an audio encoder 236, or an audio-visual fusion block 238. The video encoder 234 and the audio encoder 236 may compress the video portion 116 and the audio portion 118, respectively, for subsequent playback (e.g., when the computer-generated synthesized speech and/or text is generated, as discussed below). The audio-visual fusion block 238 may merge the video and audio from the video encoder 234 and the audio encoder 236, respectively. Additionally, the audio-visual model 232 may determine one or more segments of the audio portion 118 that is corrupted. The computer-generated synthesized speech (discussed below) provided by the system 220 may be played back (e.g., rendered, outputted, etc.) at durations the corrupted audio segments. In this regard, the audio-visual fusion block 238 may merge the video from the video encoder 234 with the audio from the audio encoder 236, as well as merge with the computer-generated synthesized speech.

The one or more models 230 may further include an SSL model 240 designed to encode clean speech audio (e.g., speech without corruption) into pronunciation tokens. The SSL model 240 may be trained on audio data. Accordingly, the SSL model 240 may learn to group sound into tokens representing different pronunciations. In this regard, the SSL model 240 may include a tokenizer 242 designed to generate and assign encoded data in the form of a token (e.g., encoded number, alphanumeric phrase) to a learned sound, effectively assigning a token to a letter or sequence of letters, thus encoding the audio data. The SSL model 240, when trained, may create training data train the audio-visual model 232. In this regard, given a multimedia file that includes both video and audio, the audio-visual model 232, once trained, is designed to predict the pronunciation tokens. The audio-visual model 232 may generate a token to each perceived sound that may be made based on the pronunciation data.

The one or more models 230 may further include a TTS model 244 (TOKEN-TO-SPEECH MODEL). Similar to the audio-visual model 232, the TTS model 244 may also be trained by data generated by the SSL model 240. In one or more implementations, the TTS model 244 includes a pseudo TTS model. The TTS model 244, when trained, may generate synthesized speech (e.g., computer-generated synthesized speech and/or computer-generated text), representing the pronunciation of the speech predicted by the audio-visual model 232. In this regard, the system 220 may generate an audio output 250 in the form synthesized speech, with the synthesized speech representing clean speech. In one or more implementations, the synthesized speech (e.g., the audio output 250) from the TTS model 244 may be merged with the video from the video portion 116 of the media file 102. Moreover, in one or more implementations, the corrupted audio in the audio portion 118 of the media file 102 is substituted with, or replaced by, the computer-generated synthesized speech (e.g., the audio output 250) from the TTS model 244. Beneficially, the media file 102 may be played back with computer-generated synthesized speech and/or synthesized text in lieu of corrupted audio, giving viewers of the media file 102 an enhanced version of the media file 102, particularly with the likelihood of increased comprehension of the media file 102 due in part to the computer-generated synthesized speech.

The system 220 may also synchronize the computer-generated synthesized speech with the mouth movement of the person (e.g., person 104 shown in FIG. 1). In this regard, the computer-generated synthesized speech may be presented and played back to viewers in a manner that is synchronized (e.g., coincides and aligns) with the mouth movement of the person. Accordingly, the computer-generated synthesized speech and/or text may be heard simultaneously with the person's mouth movement shown on a display without delays or without being played ahead of the person's mouth movement. Beneficially, the corrupted audio may be replaced by the computer-generated synthesized speech.

Further, the system 220 may determine corrupted portion(s) of the audio portion 118, including the respective durations of the corrupted portion(s). In this regard, the system 220 may remove (e.g., mute) the audio portion 118 of each corrupted portion for the duration of the individual corrupted audio portion of the audio portion 118. Further, the system 220 may play (e.g., render, output) the computer-generated synthesized speech for the duration of each corrupted portion(s) of the audio portion 118 while muting the corrupted portion(s) of the audio portion 118.

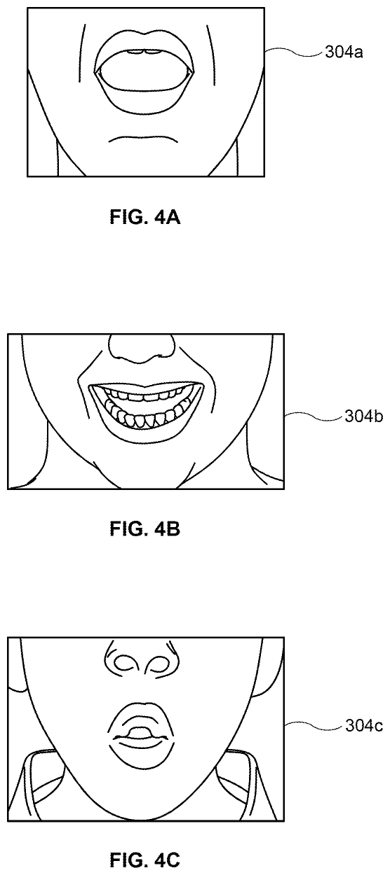

FIG. 4A, FIG. 4B, and FIG. 4C illustrate exemplary movements of a person, in accordance with aspects of the present disclosure. Referring to FIG. 4A, a person 304a is making an “ahh” sound. Referring to FIG. 4B, a person 304b is making an “eee” sound. Referring to FIG. 4C, a person 304c is making an “ohh” sound. Each of the mouth movements of the persons 304a, 304b, and 304c represents a respective phonetic unit. The sounds made by the persons 304a, 304b, and 304c may be used as training data for the SSL model 240 (shown in FIG. 3). For example, the SSL model 240 may be trained by receiving image data of each of the persons 304a, 304b, and 304c, as well as the associated sound made by the persons 304a, 304b, and 304c, based on the respective mouth movements and/or mouth placement of the persons 304a, 304b, and 304c. Additionally, the SSL model 240 may be trained with textual data that corresponds to each sound made by the persons 304a, 304b, and 304c. The sounds made by the persons 304a, 304b, and 304c are exemplary, and several additional mouth movements, associated sounds, and associated textual data may be used as training data.

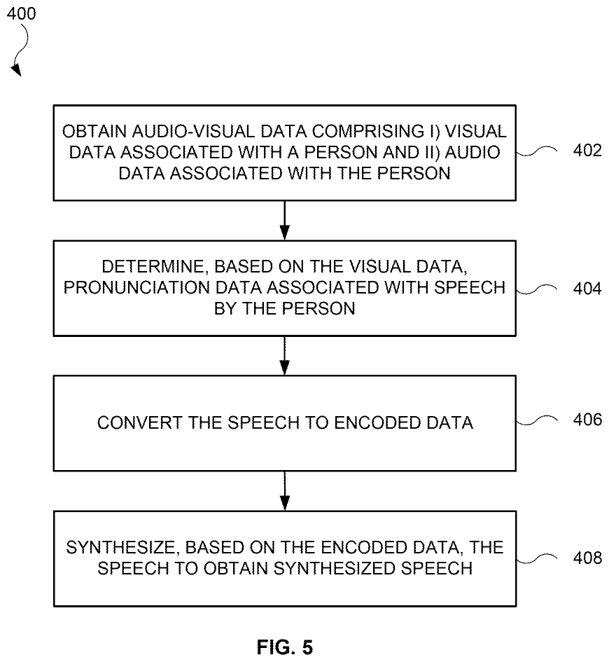

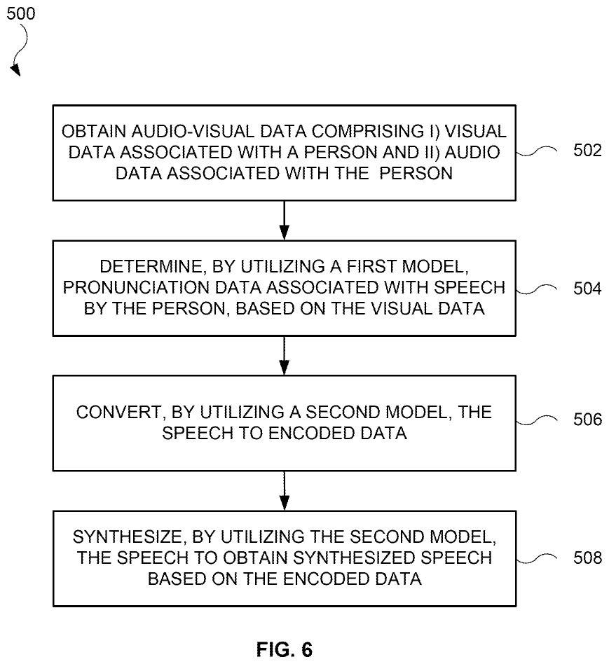

FIG. 5 and FIG. 6 illustrate examples of flowcharts showing operations for devices that may reconstruct speech from a multimedia file and/or multimedia content (e.g., media file and/or media content), in accordance with aspects of the present disclosure. Each of the flowcharts shown and/or described include operations that may be carried out by a system (e.g., system 220 shown in FIGS. 2 and 3). Accordingly, the steps of the flowcharts may be implemented in part by a display, a speaker, and one or more processors, and/or a display, and/or a speaker, or the like, as non-limiting examples. As yet another example, the steps of the flowcharts may be implemented in part by a medium (e.g. a non-transitory computer-readable medium storing instructions executable by a device (e.g., one or more processors)).

FIG. 5 illustrates an example of a flowchart 400 illustrating operations for devices that may reconstruct speech from a multimedia file and/or multimedia content, in accordance with aspects of the present disclosure. At operation 402, audio-visual data is obtained. The audio-visual data may include i) visual data associated with a person and ii) audio data associated with the person. The audio data may include corrupted audio data. At operation 404, pronunciation data is determined based on the visual data. The pronunciation data may further be based on the corrupted audio data, when present. The pronunciation data may be associated with speech by the person. At operation 406, the speech is converted to encoded data. At operation 408, the speech is synthesized to obtain synthesized speech based on the encoded data.

FIG. 6 illustrates an example of a flowchart 500 illustrating alternate operations for devices that may reconstruct speech from a multimedia file and/or multimedia content, in accordance with aspects of the present disclosure. At operation 502, audio-visual data is obtained. The audio-visual data may include i) visual data associated with a person and ii) audio data associated with the person. The audio data may include corrupted audio data. At operation 504, pronunciation data is determined utilizing a first model. The pronunciation data may be associated with speech by the person based on the visual data. The pronunciation data may further be based on the corrupted audio data, when present. At operation 506, the speech is converted, utilizing a second model, to encoded data. At operation 508, utilizing the second model, the speech is synthesized to obtain synthesized speech based on the encoded data.

FIG. 7 illustrates an example of an artificial reality system 600. The disclosed subject matter herein (e.g., one or more portions of system 220) may be incorporated into artificial reality system 600. The artificial reality system 600 may include a head-mounted display (HMD) 610 (e.g., smart glasses and/or augmented/virtual reality device) comprising a frame 612, one or more displays 614, a computing device 608 (also referred to herein as computer) and a controller 604. In some examples, the HMD 610 may capture one or more items of text from one or more images/videos associated with a real world environment in the field of view of one or more cameras (e.g., cameras 616, 618) of the artificial reality system 600. The HMD 610 may utilize the captured text from the one or more images/videos to trigger one or more actions/functions by the artificial reality system 600. The displays 614 may be transparent or translucent allowing a user wearing the HMD 610 to look through the displays 614 to see the real world (e.g., real world environment) and displaying visual artificial reality content to the user at the same time. The HMD 610 may include an audio device 606 (e.g., speakers/microphones) that may provide audio artificial reality content to users. The HMD 610 may include one or more cameras 616, 618 which may capture images and/or videos of environments. In one exemplary embodiment, the HMD 610 may include a camera(s) 618 which may be a rear-facing camera tracking movement and/or gaze of a user's eyes.

One of the cameras 616 may be a forward-facing camera capturing images and/or videos of the environment that a user wearing the HMD 610 may view. The camera(s) 616 may also be referred to herein as a front camera(s). The HMD 610 may include an eye tracking system to track the vergence movement of the user wearing the HMD 610. In one exemplary embodiment, the camera(s) 618 may be the eye tracking system. In some exemplary embodiments, the camera(s) 618 may be one camera configured to view at least one eye of a user to capture a glint image(s) (e.g., and/or glint signals). The camera(s) 618 may also be referred to herein as a rear camera(s). The HMD 610 may include a microphone of the audio device 606 to capture voice input from the user. The artificial reality system 600 may further include a controller 604 comprising a trackpad and one or more buttons. The controller 604 may receive inputs from users and relay the inputs to the computing device 608. The controller 604 may also provide haptic feedback to one or more users. The computing device 608 may be connected to the HMD 610 and the controller 604 through cables or wireless connections. The computing device 608 may control the HMD 610 and the controller 604 to provide the augmented reality content to and receive inputs from one or more users. In some example embodiments, the controller 604 may be a standalone controller or integrated within the HMD 610. The computing device 608 may be a standalone host computer device, an on-board computer device integrated with the HMD 610, a mobile device, or any other hardware platform capable of providing artificial reality content to and receiving inputs from users. In some exemplary embodiments, the HMD 610 may include an artificial reality system/virtual reality system.

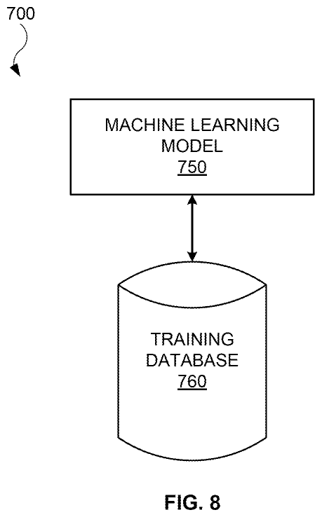

FIG. 8 illustrates an example of a machine learning framework 700 including machine learning model 750 and training database 760, in accordance with aspects of the present disclosure. The machine learning framework 700 may be hosted locally in a computing device or hosted remotely. For purposes of illustration and not of limitation, for example, the machine learning framework 700 may be hosted locally in the system 220 shown in FIG. 3. The training database 760 may include several tasks (e.g., speech recognition tasks, self-supervised speech learning tasks). Using the training database 760, the machine learning framework 700 may train the machine learning model 750 to translate received text from one language to another, or vice versa. In some aspects, for example, the machine learning model 750 may be stored by a computing device. In other aspects, for example, the machine learning model 750 may reside within a computing system, such as a portable electronic device, an HMD, a server, or the like.

The training database 760 may include a plurality of training datasets, which may include one or more word sequences in the form of phrases and/or sentences. The one or more word sequences may include labeled and/or unlabeled data. Word sequences may be labeled as including a mouth movement. Also, word sequences may be labeled as including particular sound. The labeled training datasets may be used, for example, to train a machine translation model, such as the machine learning model 750. The unlabeled training datasets may be used, for example, to validate the training. The training database 760 employed by the machine learning framework 700 may be fixed or updated periodically. One or more models 230 may be used in a similar or the same manner as the machine learning model 750.

Methods, systems, or apparatuses, among other things, as described herein may provide for speech reconstruction. A method, system, computer readable storage medium, or apparatus may determine speech in the presence of multiple, different forms of corrupted audio. The speech recognition system may include a pseudo audio-visual model (P-AVSR) that may receive data that may include both video (of a person/speaker) as well as audio. The audio may include corrupted audio (e.g., background noise, speech from other people) and may determine textual data from visual content (e.g., a person's mouth movements). Thus, the audio-visual model may rely on visual cues in the form of phonetic units to determine the textual data from speech. The speech recognition system may include a self-supervised learning (SSL) tokenizer that may receive the determined textual data and may convert the textual data into clean speech. The SSL tokenizer may determine sounds made by a letter or sequence of letters, thus determining the sounds made based on the textual data. The sounds recognized/determined by the SSL tokenizer may include human speech. The determined speech (e.g., the human speech) may be synthesized to match the received textual data, and may be presented as computer-generated synthesized speech and/or text. All combinations (including the removal or addition of steps) in this paragraph are contemplated in a manner that is consistent with the other portions of the detailed description.

In one example aspect of the present disclosure, a method enables a device(s) to reconstruct speech based on a multimedia file and/or multimedia content provided. The method may include obtaining audio-visual data comprising i) visual data associated with a person and ii) audio data associated with the person. The method may further include determining, based on the visual data, textual data associated with speech by the person. The method may further include converting the speech to encoded data. The method may further include synthesizing, based on the encoded data, the speech to obtain synthesized speech. All combinations (including the removal or addition of steps) in this paragraph and previous paragraphs are contemplated in a manner that is consistent with the other portions of the detailed description.

In an example aspect of the present disclosure, a device to reconstruct speech based on a multimedia file and/or multimedia content is provided. The device may include one or more processors and a memory including computer program code instructions. The memory and computer program code instructions are configured to, with at least one of the processors, cause the device to obtain audio-visual data comprising i) visual data associated with a person and ii) audio data associated with the person. The memory and computer program code may be configured to, with the processor, cause the device to determine, utilizing a first model, textual data associated with speech by the person, based on the visual data. The memory and computer program code may be configured to, with the processor, cause the device to convert, utilizing a second model, the speech to encoded data. The memory and computer program code may also be configured to, with the processor, cause the device to synthesize, utilizing the second model, the speech to obtain synthesized speech based on the encoded data. In some examples of the present disclosure, the memory and computer program code may also be configured to, with the processor, cause the device to present the audio-visual data and the synthesized speech. In some aspects of the present disclosure, the device may present, by a display or a speaker, the audio-visual data or the synthesized speech. For example, the display may play or render the visual content of the audio-visual data and the speaker may play or output the audio content of the audio-visual data or the synthesized speech. All combinations (including the removal or addition of steps) in this paragraph and previous paragraphs are contemplated in a manner that is consistent with the other portions of the detailed description.

In an example aspect of the present disclosure, a computer program product may enable a device(s) to reconstruct speech based on a multimedia file and/or multimedia content provided. The computer program product may include at least one computer-readable storage medium having computer-executable program code instructions stored therein. The computer-executable program code instructions may include program code instructions configured to obtain audio-visual data comprising i) visual data associated with a person and ii) audio data associated with the person. The computer program product may further include program code instructions configured to determine, utilizing a first model, textual data associated with speech by the person based on the visual data. The computer program product may further include program code instructions configured to convert, utilizing a second model, the speech to encoded data. The computer program product may further include program code instructions configured to synthesize, utilizing the second model, the speech based on the encoded data to obtain synthesized speech. All combinations (including the removal or addition of steps) in this paragraph and previous paragraphs are contemplated in a manner that is consistent with the other portions of the detailed description.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary,” as used herein, is not provided to convey any qualitative assessment, but instead merely to convey an illustration of an example. Thus, use of any such terms should not be taken to limit the spirit and scope of embodiments of the present application. It is to be understood that the methods and systems described herein are not limited to specific methods, specific components, or to particular implementations.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented Reality (AR)/Virtual Reality (VR)/Mixed Reality (MR).

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only, and is not intended to be limiting.

It is to be appreciated that certain features of the disclosed subject matter which are, for clarity, described herein in the context of separate embodiments, can also be provided in combination in a single embodiment. Conversely, various features of the disclosed subject matter that are, for brevity, described in the context of a single embodiment, can also be provided separately, or in any sub-combination. Further, any reference to values stated in ranges includes each and every value within that range. Any documents cited herein are incorporated herein by reference in their entireties for any and all purposes.

It is to be understood that the methods and systems described herein are not limited to specific methods, specific components, or to particular implementations. It is also to be understood that the terminology used herein is for the purpose of describing particular embodiments only and is not intended to be limiting.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim. References in this description to “an example”, “one example”, or the like, may mean that the particular feature, function, or characteristic being described is included in at least one example of the present embodiments. Occurrences of such phrases in this specification do not necessarily all refer to the same example, nor are they necessarily mutually exclusive.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method, comprising:
obtaining audio-visual data comprising visual data associated with a person and audio data associated with the person;
determining, based on the visual data, pronunciation data associated with speech by the person;
converting the speech to encoded data; and
synthesizing, based on the encoded data, the speech to obtain synthesized speech.

2. The method of claim 1, further comprising:
outputting the synthesized speech while playing or rendering the visual data, wherein the synthesized speech is synchronized with movement associated with the person.

3. The method of claim 2, further comprising in response to determining a corrupted portion of the audio data:
determining a duration in which the corrupted portion occurs; and
outputting the synthesized speech during the duration.

4. The method of claim 1, wherein the determining the pronunciation data associated with the speech comprises determining, by a first model using the visual data, a visual cue of the person.

5. The method of claim 4, wherein converting the speech to the encoded data comprises converting, by the first model, the visual cue into the pronunciation data.

6. The method of claim 5, wherein the synthesizing the speech comprises generating the synthesized speech based on the pronunciation data determined based on the visual cue.

7. The method of claim 5, wherein the converting the speech to the encoded data comprises converting, by a second model, the speech to the encoded data, wherein the second model is trained to encode the visual cue by assigning a code to the visual cue.

8. The method of claim 1, further comprising:
removing background noise from the audio data, wherein the determining the pronunciation data is based on the visual data that comprises visual cues associated with the person.

9. The method of claim 8, wherein the visual cues comprise one or more mouth movements associated with the person.

10. A device, comprising:
one or more processors; and
at least one memory storing instructions, that when executed by the one or more processors, cause the device to:
obtain audio-visual data comprising visual data associated with a person and audio data associated with the person;
determine, by utilizing a first model, pronunciation data associated with speech by the person, based on the visual data;
convert, by utilizing a second model, the speech to encoded data; and
synthesize, by utilizing the second model, the speech to obtain synthesized speech based on the encoded data.

11. The device of claim 10, wherein when the one or more processors further execute the instructions further causes the device to:
present, by a display and a speaker, the audio-visual data and the synthesized speech; and
synchronize the synthesized speech with movement of the person while the audio-visual data is presented.

12. The device of claim 10, wherein when the one or more processors further execute the instructions further causes the device to in response to determining a corrupted portion of the audio data:
determine a duration in which the corrupted portion occurs; and
present the synthesized speech during the duration.

13. The device of claim 10, wherein when the one or more processors further execute the instructions further causes the device to:
determine the pronunciation data associated with the speech based on determining, by the first model utilizing the visual data, a visual cue associated with the person.

14. The device of claim 13 wherein when the one or more processors further execute the instructions further causes the device to:
convert the speech to the encoded data based on converting, by the first model, the visual cue into the pronunciation data.

15. The device of claim 14, wherein when the one or more processors further execute the instructions further causes the device to:
generate the synthesized speech based on the pronunciation data determined based on the visual cue.

16. The device of claim 14, wherein the second model is trained to encode the visual cue by assigning a code to the visual cue.

17. The device of claim 10, wherein when the one or more processors further execute the instructions further causes the device to:
remove background noise from the audio data; and
determine the pronunciation data based on the visual data that comprises visual cues of the person.

18. A non-transitory computer-readable medium storing instructions that, when executed, cause:
obtaining audio-visual data comprising visual data associated with a person and audio data associated with the person;
determining, by utilizing a first model, pronunciation data associated with speech by the person based on the visual data;
converting, by utilizing a second model, the speech to encoded data; and
synthesizing, by utilizing the second model, the speech based on the encoded data to obtain synthesized speech.

19. The non-transitory computer-readable medium of claim 18, wherein the instructions, when executed, further cause:
outputting, by utilizing the second model, the synthesized speech as computer-generated synthesized speech; and
outputting the computer-generated synthesized speech while playing or rendering the audio-visual data, wherein the computer-generated synthesized speech is synchronized with movement associated with the person.

20. The non-transitory computer-readable medium of claim 19, wherein the instructions, when executed, further cause in response to determining a corrupted portion of the audio data:
determining a duration in which the corrupted portion occurs; and
outputting the synthesized speech during the duration.
